(19) United States
(12) Patent Application Publication
(10) Pub. No.: US 2015/0277265 A1
(43) Pub. Date: Oct. 1, 2015

(54) ROLLER MEMBER, ROLLER SUPPORTING MECHANISM, AND METALLIC SHAFT

(71) Applicant: CANON KABUSHIKI KAISHA, Tokyo (JP)

(72) Inventors: Hiroomi Matsuzaki, Mishima-shi (JP); Koji Yamaguchi, Numazu-shi (JP); Kohki Kamata, Machida-shi (JP); Motomi Suzuki, Kashiwa-shi (JP); Yoshiyuki Beniya, Abiko-shi (JP); Yukinori Nagata, Mishima-shi (JP); Satoru Yamada, Numazu-shi (JP)

(21) Appl. No.: 14/673,532

(22) Filed: Mar. 30, 2015

(30) Foreign Application Priority Data
Mar. 31, 2014 (JP) 2014-074541

(51) Int. Cl. G03G 15/02; G03G 15/08; F16C 13/00; B25F 5/02

(52) U.S. Cl. CPC G03G 15/0233; G03G 15/0808

(57) ABSTRACT

A roller member used in an image forming apparatus including: a metallic shaft; and a covering layer, wherein the metallic shaft has a cylindrical shape formed so that one end portion and the other end portion of the metallic plate oppose each other, the one end portion and the other end portion each include a straight portion, a projection, and a depression, the projections on the one end portion engage the depressions on the other end portion, a straight area is located outside a projection and depression area in which the projection on the one end portion and the projection on the other end portion are aligned in an axial direction of the metallic shaft, and the projection and depression area is entirely covered with the covering layer and at least part of the straight area is exposed from the covering layer.

### BACKGROUND OF THE INVENTION

1. Field of the Invention

This disclosure relates to a roller member used for an image forming apparatus, a roller supporting mechanism provided with the roller member, and a metallic shaft used in the roller member. An image forming apparatus is an apparatus that forms images on recording media.

Examples of an image forming apparatus include, for example, electrophotographic copying machines using an electrophotographic image forming process, electrophotographic printers (LED printers, laser beam printers), facsimile apparatuses, and word processors.

2. Description of the Related Art

In the related art, an electrophotographic image forming apparatus (hereinafter, referred to as an image forming apparatus) includes a photosensitive member and a process device configured to act on the photosensitive member. Examples of the process device include a voltage application apparatus configured to apply electric charge on the photosensitive drum, a developing device configured to supply developer (hereinafter, referred to as “toner”) to the photosensitive drum, and a cleaning device configured to clean toner failed to be transferred and remaining on a surface of the photosensitive drum.

Examples of a charging device in the voltage application apparatus include a roller charging system using a roller member. In the roller charging system, charging of the surface of the photosensitive drum is achieved by bringing a charging roller, which is a conductive resilient roller, into bias abutment with the photosensitive drum and applying a voltage thereto. The charging roller generally has a form having a resilient layer covering a metallic shaft over the entire area in a longitudinal direction other than both ends (Japanese Patent Laid-Open No. 2013-109209, pp. 11, FIG. 2).

Examples of the metallic shaft of the charging roller include a form using a cylindrical-shaped metallic shaft (Japanese Patent Laid-Open No. 2010-230748).

However, in the case of manufacturing the cylindrical-shaped metallic shaft by bending a metallic plate by a press work or the like, a mating portion (an opposed portion where one end portion and the other end portion of the metallic plate oppose each other) extending along an axial direction is present on the metallic shaft. In order to increase the strength of the metallic shaft at this time, a configuration in which a projection and depression area is provided on the mating portion and one end portion and the other end portion of the metallic plate are engaged by the projections and depressions of the metallic plate is conceivable. However, in this projection and depression area, if the metallic shaft is rotatably supported by the bearing portion, the bearing portion is caught by the projection and depression area, and hence a rotational sliding resistance may increase.

Therefore, reducing the resistance at the metallic shaft and the bearing portion at the time of rotation of the roller member while increasing the strength of the metallic shaft is required.

### SUMMARY OF THE INVENTION

In view of such a problem in the related art, there is provided a roller member used in an image forming apparatus including: a metallic shaft; and a covering layer configured to cover the metallic shaft, wherein the metallic shaft has a cylindrical shape formed so that one end portion and the other end portion of the metallic plate oppose each other, the one end portion and the other end portion each include a straight portion, a projection, and a depression, the projection on the one end portion engages the depression on the other end portion, and the projection on the other end portion engages the depression on the one end portion in an opposing area in which the one end portion and the other end portion oppose each other, a straight area in which a straight portion on the one end portion and a straight portion on the other end portion oppose each other is located outside a projection and depression area in which the projection on the one end portion and the projection on the other end portion are aligned in an axial direction of the metallic shaft, and the projection and depression area is entirely covered with the covering layer and at least part of the straight area is exposed from the covering layer.

Further features of the present invention will become apparent from the following description of exemplary embodiments with reference to the attached drawings.

### BRIEF DESCRIPTION OF THE DRAWINGS

FIG. 1 is a perspective view illustrating a charging roller of Example 1.

FIG. 2 is a cross-sectional view illustrating an image forming apparatus body and a process cartridge of an electrophotographic image forming apparatus of Example 1.

FIG. 3 is a cross-sectional view illustrating the process cartridge of Example 1.

FIG. 4 is a perspective view illustrating the image forming apparatus body and the process cartridge in a state in which an opening and closing door of Example 1 is opened.

FIG. 5 is an explanatory perspective view illustrating a configuration of the process cartridge of Example 1.

FIG. 6 is an explanatory perspective view illustrating a configuration of a cleaning unit of Example 1.

FIGS. 7A and 7B are explanatory perspective views illustrating the configuration of the cleaning unit of Example 1.

FIG. 8 is an explanatory cross-sectional view of a processing process of a charging roller of Example 1.

FIGS. 9A and 9B are an explanatory perspective views illustrating a shaft portion of the charging roller of Example 1.

FIG. 10 is an explanatory view illustrating the charging roller.

FIGS. 11A and 11B are explanatory views illustrating the charging roller of Example 1.

FIGS. 12A and 12B are explanatory perspective views illustrating a charging roller of Example 2.

FIGS. 13A to 13C are explanatory views illustrating a charging roller of Example 3.

FIG. 14A is an explanatory view illustrating the metallic plate. FIG. 14B is an explanatory view illustrating the metallic plate.

### DESCRIPTION OF THE EMBODIMENTS

### Example 1

An embodiment of this disclosure will be described with reference to the drawings in detail.

A direction of a rotational axis of an electrophotographic photosensitive drum is defined as a longitudinal direction.

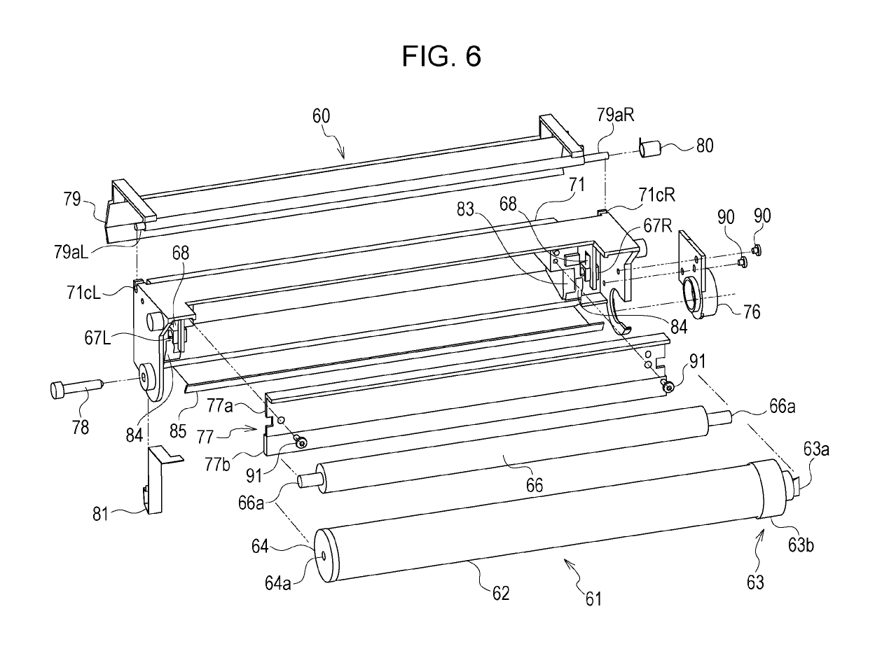

In the longitudinal direction, a side where the electrophotographic photosensitive drum receives a driving force from an image forming apparatus body is defined as a driving side (on a drive force receiving portion 63a side in FIG. 6), and a side opposite thereto is defined as a non-driving side.

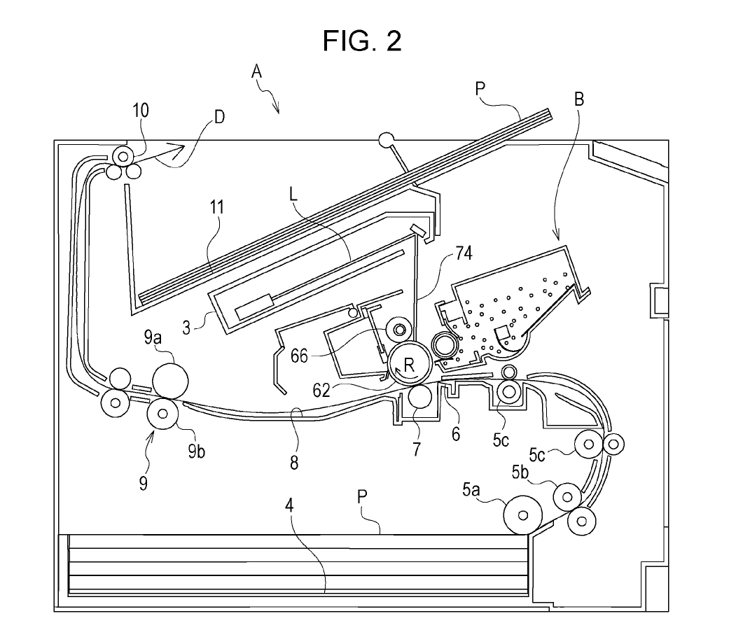

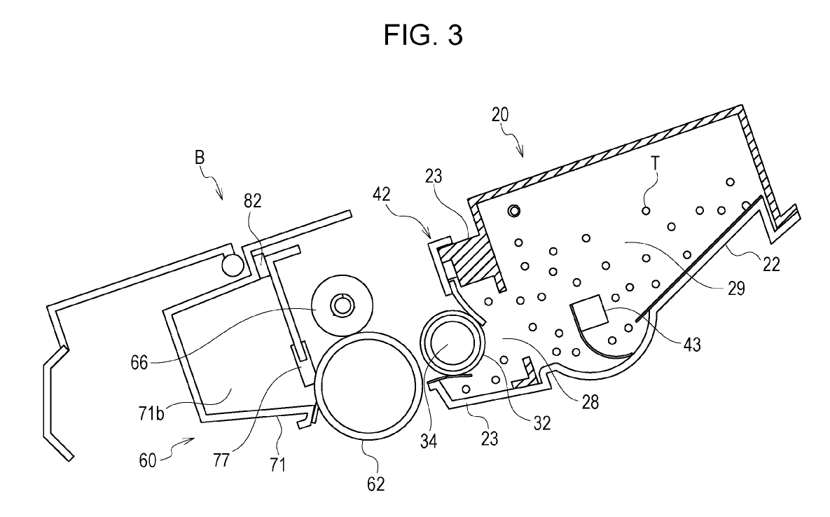

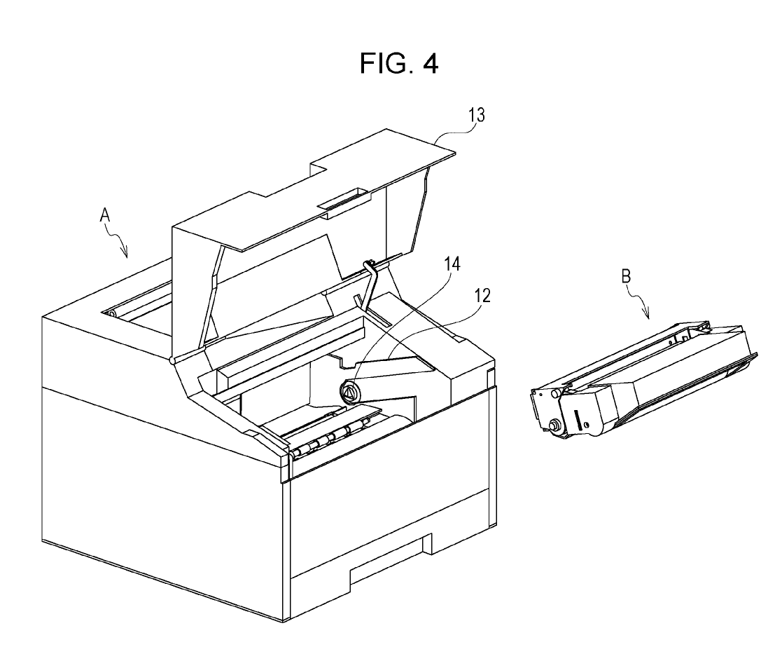

With reference to FIG. 2, FIG. 3, and FIG. 4, a general configuration and an image forming process will be described.

FIG. 2 is a cross-sectional view illustrating the image forming apparatus body (hereinafter, referred to as an apparatus body A) of the electrophotographic image forming apparatus and a process cartridge (hereinafter, referred to as a cartridge B) as an embodiment of this disclosure.

FIG. 3 is a cross-sectional view illustrating the cartridge B.

Here, the apparatus body A of the electrophotographic image forming apparatus is a portion of the electrophotographic image forming apparatus from which the cartridge B is removed.

FIG. 4 is a perspective view illustrating the image forming apparatus body A and the process cartridge B. General Configuration of Electrophotographic Image Forming Apparatus

In FIG. 2 and FIG. 4, the electrophotographic image forming apparatus is a laser beam printer using an electrophotographic technology in which the cartridge B is demountably mounted on the apparatus body A. When the cartridge B is mounted on the apparatus body A, an exposure unit 3 (laser scanner unit) is arranged in an upper side of the cartridge B.

Also, a sheet tray 4 in which a recording medium (hereinafter, referred to as a sheet material P) which is a target of image formation is stored on a lower side of the cartridge B is arranged.

In addition, the apparatus body A includes a pickup roller 5a, a feed roller pair 5b, a conveyance roller pair 5c, a transfer guide 6, a transfer roller 7, a conveyance guide 8, a fixing unit 9, a discharging roller pair 10, and a discharge tray 11 arranged in sequence along a direction of conveyance of the sheet material P. The fixing unit 9 includes a heat roller 9a and a pressurizing roller 9b.

### Image Forming Process

Subsequently, the image forming process is described schematically. On the basis of a print start signal, the electrophotographic photosensitive drum (hereinafter, referred to as a drum 62) is driven to rotate at a predetermined circumferential velocity (process speed) in a direction indicated by an arrow R.

A charging roller 66 to which a bias voltage is applied, comes into contact with an outer peripheral surface of the drum 62, and charges the outer peripheral surface of the drum 62 uniformly and evenly.

The exposure unit 3 outputs a laser beam L in accordance with image information. The laser beam L passes through an exposure window portion 74 on an upper surface of the cartridge B, and scans and exposes the outer peripheral surface of the drum 62.

Accordingly, an electrostatic latent image corresponding to the image information is formed on the outer peripheral surface of the drum 62.

In contrast, as illustrated in FIG. 3, in a developing assembly unit 20 as a developing assembly, toner T in a toner chamber 29 is stirred and conveyed by a rotation of a conveyance member 43 and fed to a toner supply chamber 28. The toner T is born on a surface of a developing roller 32 by a magnetic force of a magnet roller (fixed magnet). The toner T is controlled in layer thickness on a peripheral surface of the developing roller 32 while being charged by friction by a developing blade 42.

The toner T is transferred to the drum 62 in accordance with the electrostatic latent image, and is visualized as a toner image.

The drum 62 is an image bearing member configured to bear images (a toner image, a developer image) on the surface thereof. The developing roller 32 is a developer bearing member configured to bear developer (toner) for developing a latent image formed on the drum 62 as a toner image (developer image). As illustrated in FIG. 2, the sheet material P stored in a lower portion of the apparatus body A is fed from the sheet tray 4 by the pickup roller 5a, the feed roller pair 5b, and the conveyance roller pair 5c at the same timing as outputting of the laser beam L.

Then, the sheet material P passes through the transfer guide 6, and is fed to a transfer position between the drum 62 and the transfer roller 7. At this transfer position, the toner images are transferred in sequence from the drum 62 to the sheet material P.

The sheet material P to which the toner image is separated from the drum 62 and conveyed to the fixing unit 9 along the conveyance guide 8. The sheet material P then passes through a nip portion between the heat roller 9a and the pressurizing roller 9b which constitute part of the fixing unit 9.

At the nip portion, pressurization and heat-fixation are performed, so that the toner image is fixed to the sheet material P. The sheet material P subjected to the fixation of the toner image is conveyed to the discharging roller pair 10, and is discharged to the discharge tray 11.

In contrast, as illustrated in FIG. 3, residual toner on the outer peripheral surface of the drum 62 after the transfer is removed by a cleaning blade 77, and the drum 62 is used for the image forming process again. The toner removed from the drum 62 is stored in a waste toner chamber 71b of a cleaning unit 60.

In the above, the charging roller 66, the developing roller 32, and the cleaning blade 77 are process devices configured to act on the drum 62.

General Configuration of Cartridge

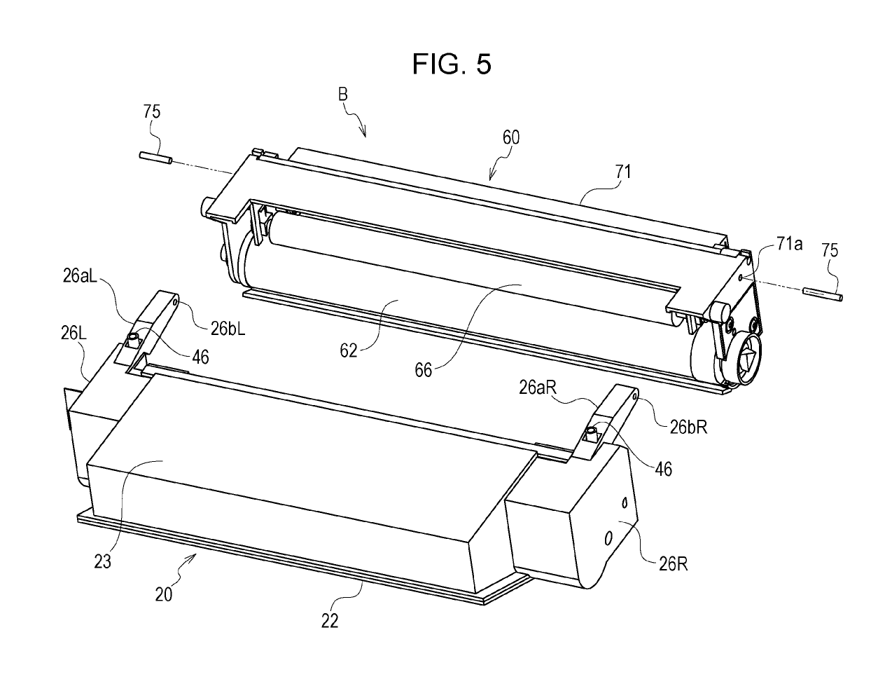

Subsequently, a general configuration of the cartridge B will be described with reference to FIG. 3 and FIG. 5.

FIG. 5 is an explanatory perspective view illustrating a configuration of the cartridge B.

The cartridge B includes the cleaning unit 60 and the developing assembly unit 20 combined with each other.

The cleaning unit 60 includes a cleaning frame member 71, the drum 62, the charging roller 66, and the cleaning blade 77.

In contrast, the developing assembly unit 20 includes a bottom member 22, a developer container 23, a first side member 26L, a second side member 26R, the developing blade 42, the developing roller 32, the magnet roller 34, the conveyance member 43, the toner T, and biasing members 46.

The cartridge B is formed by coupling the cleaning unit 60 and the developing assembly unit 20 with a coupling member 75 so as to be rotatable with each other.

Specifically, rotary hole 26bL and 26bR, extending in parallel with the developing roller 32, are formed at distal ends of arm portion 26aL and 26aR formed on the first side member 26L and the second side member 26R provided on the developing assembly unit 20 at both end portions thereof in a longitudinal direction (an axial direction of the developing roller 32).

Fitting holes 71a for fitting coupling members 75 are formed at both end portions of the cleaning frame member 71 in the longitudinal direction.

The arm portion 26aL and 26aR are aligned with predetermined positions of the cleaning frame member 71 to insert the coupling member 75 into the rotary holes 26bL and 26bR and the fitting hole 71a. Accordingly, the cleaning unit 60 and the developing assembly unit 20 are coupled so as to be rotatable about the coupling member 75 as a center.

At this time, the biasing members 46 mounted at roots of the arm portions 26aL and 26aR abut against the cleaning frame member 71, thereby biasing the developing assembly unit 20 toward the cleaning unit 60 about the coupling members 75 as a center of rotation.

Accordingly, the developing roller 32 is reliably pressed in the direction of the drum 62.

With distance retaining members (which are not illustrated) mounted on both end portions of the developing roller 32, the developing roller 32 is retained at a predetermined distance from the drum 62.

### Configuration of Cleaning Unit

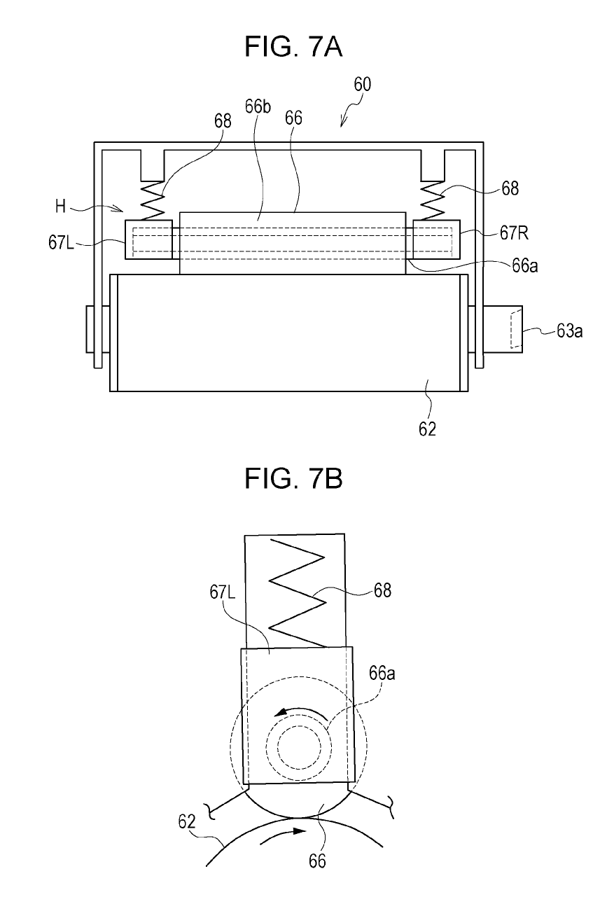

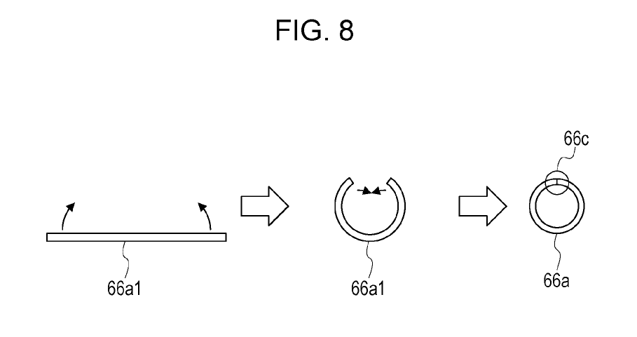

Subsequently, a configuration of the cleaning unit 60 will be described with reference to FIG. 6, FIGS. 7A and 7B, and FIG. 8.

FIG. 6 is an explanatory perspective view illustrating the configuration of the cleaning unit 60.

FIG. 7A is an explanatory front view illustrating the configuration of the cleaning unit 60. FIG. 7B is a drawing illustrating a supporting portion of the charging roller 66 viewed in a direction indicated by an arrow H. FIG. 8 is a cross-sectional view illustrating a process of formation of a shaft portion 66a from a plate into a cylindrical shape.

The cleaning blade 77 includes a supporting member 77a formed of a plate and a resilient member 77b formed of a resilient material such as urethane rubber, and is arranged at a predetermined position in the cleaning frame member 71 by fixing both ends of the supporting member 77a with screws 91.

Resilient member 77b comes into abutment with the drum 62, and removes residual toner from the outer peripheral surface of the drum 62.

The removed toner is stored in a waste toner chamber 71b (FIG. 3) of the cleaning unit 60.

A first seal member 82, a second seal member 83, a third seal member 84, and a fourth seal member 85 are fixed to predetermined positions of the cleaning frame member 71 with double-sided tape and the like.

The first seal member 82 is provided across the longitudinal direction and prevents wasted toner from leaking from a back side of the supporting member 77a of the cleaning blade 77.

The second seal member 83 prevents wasted toner from leaking from both ends of the resilient member 77b of the cleaning blade 77 in the longitudinal direction.

The third seal member 84 wipes adhered substances such as toner on the drum 62 while preventing the wasted toner from leaking out from the both ends of the resilient member 77b of the cleaning blade 77 in the longitudinal direction.

The fourth seal member 85 is provided in contact with the drum 62 across the longitudinal direction, and prevents the wasted toner from leaking out from the upstream side of the drum 62 in a direction of rotation with respect to the cleaning blade 77.

An electrode plate 81, a biasing member 68, and charging roller bearings (bearing portions) 67L and 67R are mounted on the cleaning frame member 71.

A metallic shaft (hereinafter, referred to as the shaft portion 66a) of the charging roller 66 is fitted to the charging roller bearings 67L and 67R. The charging roller 66 is biased by the biasing member 68 with respect to the drum 62, and is rotatably supported by the charging roller bearings 67L and 67R. The biasing member 68 is driven to rotate in association with the rotation of the drum 62. In other words, the charging roller 66 is supported by the cleaning unit 60 via charging roller bearings 67 (67L and 67R). The cleaning unit 60 is a roller supporting mechanism configured to support the charging roller 60.

The charging roller 66 is configured by covering the hollow shaft portion 66a with a conductive resilient layer 66b over the entire area in the longitudinal direction except for both ends. The shaft portion 66a is a cylindrical-shaped metallic shaft.

The resilient layer 66b and the shaft portion 66a are joined by an adhesive agent. The shaft portion 66a is a member formed a conductive metallic plate such as a stainless steel plate or a galvanized steel plate into a cylindrical shape by a press work. Here, using the hollow shaft portion 66a formed by a press work is used is to achieve a weight reduction of the charging roller 66, the cartridge having the charging roller 66, and the image forming apparatus by reducing the weight of the shaft portion 66a. If the shaft portion 66a can be formed by processing the metallic plate, a cost reduction of the shaft portion 66a is achieved.

The electrode plate 81, the biasing member 68, the charging roller bearing 67L, and the shaft portion 66a have conductivity. The electrode plate 81 is in contact with a power feeding portion (which is not illustrated) of the apparatus body A. With these members using as a power feeding route, power is supplied to the charging roller 66.

The drum 62 is coupled integrally with a flange 64 and a flange 63 to achieve an electrophotographic photosensitive drum unit (hereinafter, referred to as a drum unit 61). This coupling method uses caulking, adhesion, welding, and the like.

An earth contact point and the like (which is not illustrated) is coupled to the flange 64. The flange 63 includes a drive force receiving portion 63a configured to receive a drive force from the apparatus body A and a flange gear portion 63b configured to transmit the drive force to the developing roller 32.

A bearing member 76 is integrally fixed to a driving side of the cleaning frame member 71 with a screw 90, and a drum shaft 78 is fixed to a non-driving side of the cleaning frame member 71 by press fitting.

The bearing member 76 fits the flange 63, and the drum shaft 78 fits a hole 64a of the flange 64.

Accordingly, the drum unit 61 is rotatably supported by the cleaning frame member 71.

A protecting member 79 is rotatably supported by the cleaning frame member 71 so that a protection (light-shielding) of the drum 62 and exposure are allowed.

A biasing member 80 is mounted on a shaft portion 79aR on a driving side of the protecting member 79, and biases the protecting member 79 in a direction to protect the drum 62.

A shaft portion 79aL on a non-driving side and the shaft portion 79aR on the driving side of the protecting member 79 fit bearing portions 71cL and 71cR of the cleaning frame member 71.

### Configuration of Charging Roller 66

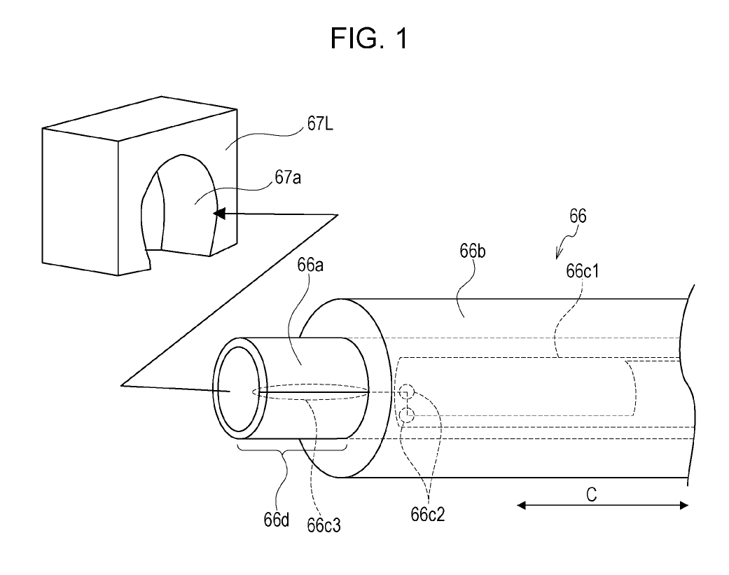

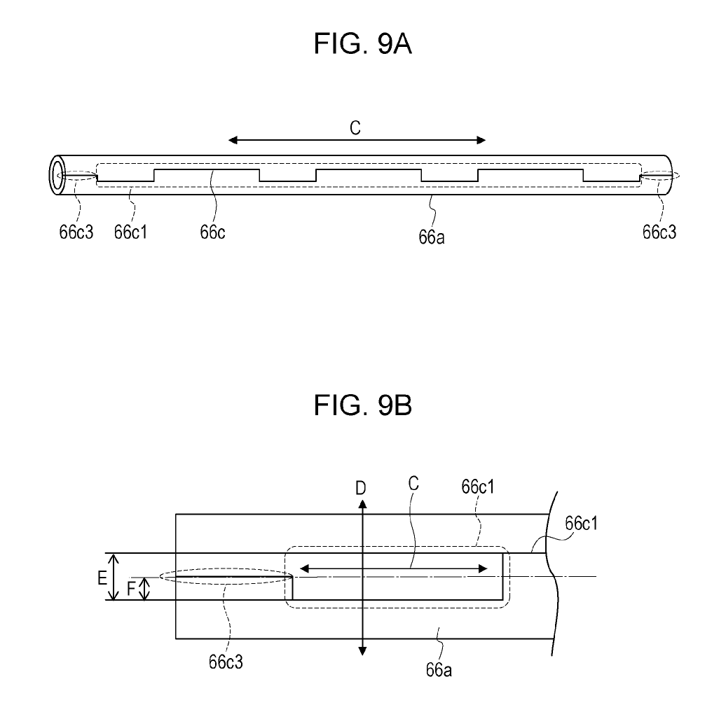

A configuration of the charging roller 66 will be described with reference to FIG. 1, FIG. 8, FIGS. 9A and 9B, FIG. 10, FIGS. 11A and 11B, and FIG. 14A.

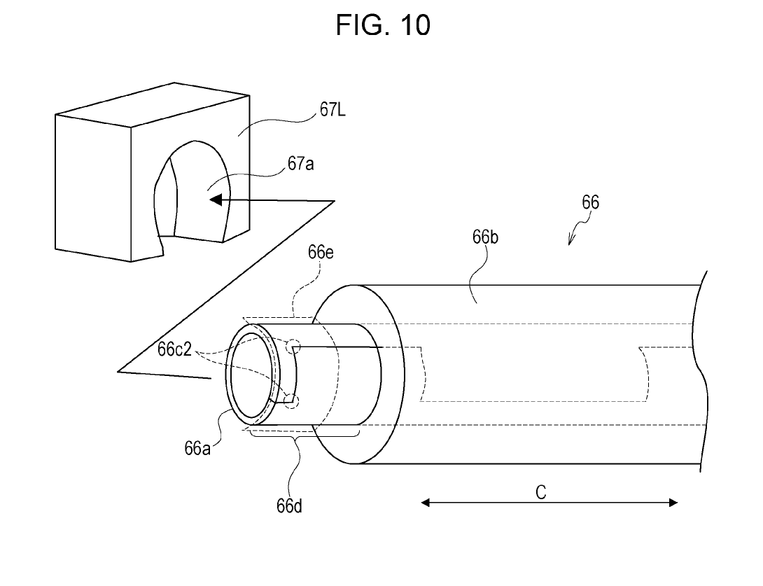

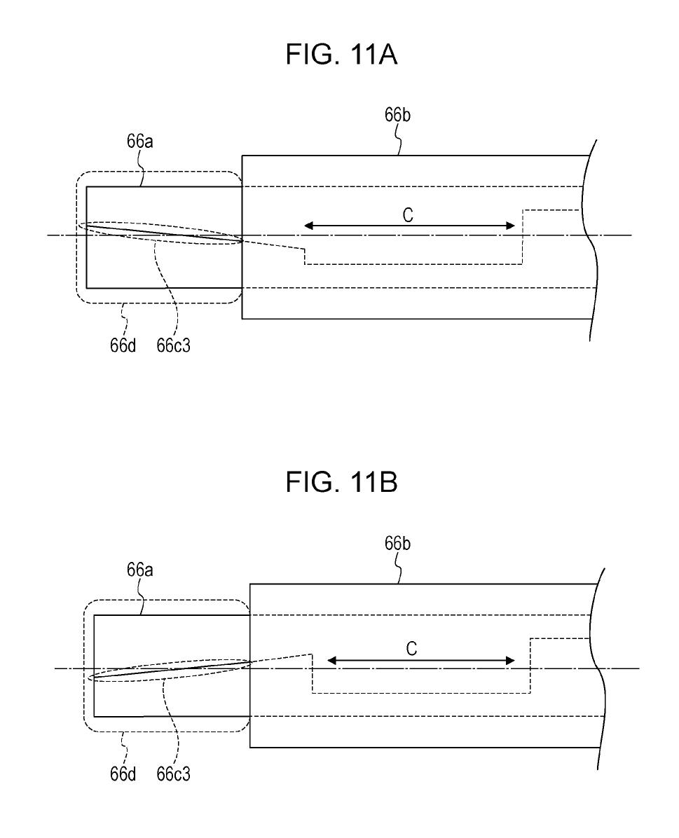

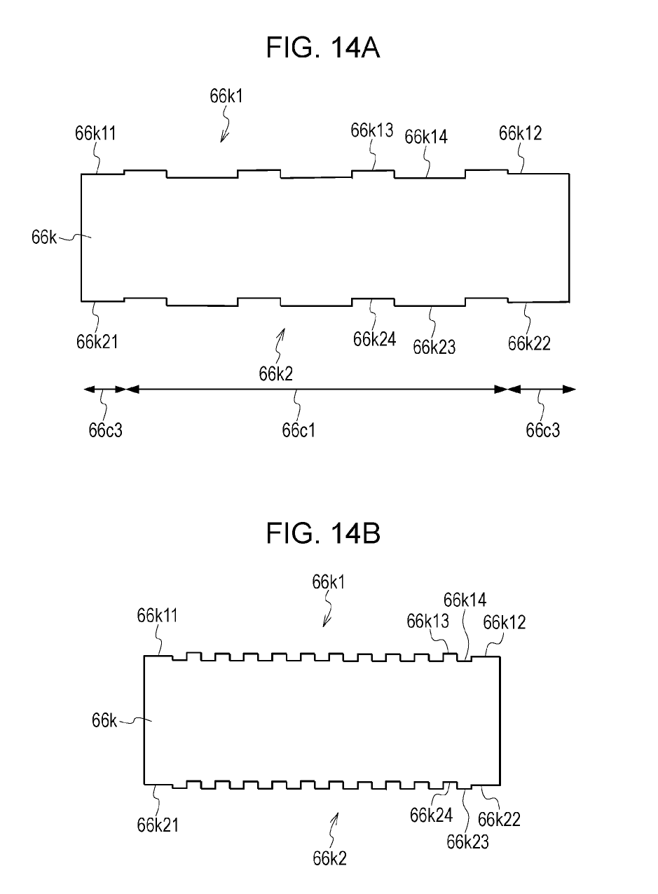

FIG. 1 is a perspective view illustrating the charging roller 66 and the charging roller bearing 67L. FIG. 9A is a perspective view illustrating a shaft portion 66a. FIG. 9B is a detailed drawing illustrating an end portion 66d of the shaft portion 66a of the charging roller 66. FIG. 10 is a perspective view illustrating the charging roller 66 and the charging roller bearing 67L in which this disclosure is not implemented. FIGS. 11A and 11B are detailed drawings illustrating the end portion 66d of the shaft portion 66a of the charging roller 66. FIG. 14A is an explanatory view illustrating the metallic plate.

The shaft portion 66a of the charging roller 66 as illustrated in FIG. 8 is a member formed by shaping into a cylindrical shape in outer diameter by pressing a conductive metallic plate 66a1. A mating portion (an opposing area of end portions of the metallic plate) 66c of the metallic plate extending along an axial direction C of the shaft portion 66a is formed.

Here, in this example, an outer diameter of the shaft portion 66 is φ6 mm, the entire length in the axial direction C is 252.5 mm. An outer diameter and the entire length required in terms of function may be selected as needed.

With the provision of a plurality of projection and depression portions 66c1 on the mating portion 66c, a desired strength is provided on the shaft portion 66a. The larger the number of depressions and projections, the stronger the shaft portion becomes, which is preferable. However, the strength required in terms of the function of the product may be selected as needed.

FIG. 14A illustrates a metallic plate 66k before a press work. The metallic plate 66k includes straight portions 66k11 and 66k12, a plurality of projections 66k13, and a plurality of depressions 66k14 on one end portion (a first end portion) 66k1. The metallic plate 66k also includes straight portions 66k21 and 66k22, a plurality of projections 66k23, and a plurality of depressions 66k24 on the other end portion (a second end portion) 66k2. When the metallic plate 66k is bent so that the one end portion 66k1 and the other end portion 66k2 oppose each other by the press work, a cylindrical-shaped shaft portion 66a is formed.

Here, the mating portion 66c has the projection and depression portion 66c1 including the plurality of depressions and projections and two straight areas 66c3 as illustrated in FIG. 9A and FIG. 9B. The straight areas 66c3 are provided on both end sides in the axial direction C, and the projection and depression area 66c1 is provided between the two straight portions 66c3. The two straight areas 66c3 are arranged outside in the axial direction of the metallic shaft 66a than the projection and depression area 66c1.

As is understood by comparing FIG. 14A and FIG. 9A, as a result that the metallic plate 66k is bent, the opposing area in which the one end portion 66k1 and the other end portion 66k2 oppose each other corresponds to the mating portion 66c of the metallic shaft 66a.

In particular, an opposing area in which the straight portion 66k11 provided on the one end portion 66k1 and the straight portion 66k21 provided on the other end portion 66k2 of the metallic plate 66k oppose each other corresponds to the straight areas 66c3 of the mating portion 66c.

In the same manner, an opposing area in which the straight portion 66k12 provided on the one end portion 66k1 and the straight portion 66k22 provided on the other end portion 66k2 of the metallic plate 66k oppose each other corresponds to the straight areas 66c3 of the mating portion 66c.

The projections 66k13 provided on the one end portion 66k1 of the metallic plate 66k engage the depressions 66k24 provided on the other end portion 66k2, respectively. In the same manner, the projections 66k23 provided on the other end portion 66k2 engage the depressions 66k14 provided on the one end portion 66k1, respectively.

The projections 66k13, the depressions 66k24, the projections 66k23, and the depressions 66k14 provided on the metallic plate 66k form the projections and depressions of the projection and depression area 66c1 on the mating portion 66c of the metallic shaft 66a. More specifically, the projection and depression area 66c1 provided on the mating portion 66c is an area in which a plurality of the projections 66k13 provided on the one end portion 66k1 of the metallic plate 66k and a plurality of the projections 66k23 provided on the other end portion 66k2 are formed so as to be arranged alternately.

As illustrated in FIG. 9B, in a vertical direction D with respect to the axial direction C of the shaft portion 66a, a relationship between a projecting amount (=depressing amount) E of the projection and depression portion 66c1 of the mating portion 66c and a projecting amount F of the straight portion 66c3 is E>F.

In this example, the value E of the shaft portion is 2 mm, and the value F is 1 mm, which is half the value E. However, a desired value may be selected as the value E within a range from 1 to 3 mm.

Subsequently, an arrangement relationship between the shaft portion 66a and the resilient layer 66b will be described. By covering the projection and depression portion 66c1 with the resilient layer (covering layer) 66b, corner portions 66c2 of the projection and depression area 66c1 (recessed corners of the depressions and projecting corners of the projections, or portions where these recessed corners and projecting corners engage) are covered entirely with the resilient layer 66b as illustrated in FIG. 1. With this arrangement, the corner portions 66c2 are not exposed to the end portions (exposed portion) 66d of the shaft portions 66a which are not covered with the resilient layer 66b. Therefore, sliding portions 67a of the bearings 67L and 67R which come into sliding contact (contact) with the shaft portion 66a and the corner portions 66c2 do not overlap with each other.

In contrast, at least part of the straight areas 66c3 is exposed from the resilient layer 66b. In other words, in a contact portion of the shaft portion 66a which comes into contact with the bearings 67L and 67R, the mating portion 66c are entirely formed of the straight areas 66c3. The contact portion of the shaft portion 66a that comes into contact with the charging roller bearings 67L and 67R do not have the projection and depression area 66c1.

The straight areas 66c3 can hardly be caught by the charging roller bearings 67L and 67R at the time of rotation of the charging roller, and a sliding resistance between the charging roller and the charging roller bearings 67L and 67R becomes small.

In contrast, as an example in which this disclosure is not implemented, the case where the corner portions 66c2 of the projection and depression area 66c1 is exposed to the end portion 66d, and the sliding portion 67a of the bearing 67L (a slid portion on the 66a side is 66e) and the corner portions 66c2 overlap with each other is illustrated in FIG. 10. At this time, the bearing 67L receives a sliding resistance due to a minute gap or level difference of the corner portions 66c2. The sliding resistance impairs the rotation of the charging roller and causes an image failure.

With the configuration described thus far, by preventing the corner portions 66c2 from overlapping with the sliding portion 67a of the bearing, an occurrence of the image failure can be restrained.

In FIG. 1, the mating portion 66c (that is, the straight area 66c3) extends in a direction parallel to the axial direction C of the shaft portion 66a in the end portion 66d of the shaft portion 66a. However, as the mating portion 66d illustrated in FIG. 11, the straight area which does not extend in parallel to the axial direction C of the shaft portion 66a is also applicable.

A configuration having no gap in engagement of the depressions and the projections at the projection and depression area 66c1 of the mating portion 66c is preferable in terms of strength. However, a gap may be generated in part of engagement between the depressions and the projections.

In the description given above, the charging roller 66 is exemplified as the roller member to be employed in this example. However, in the image forming apparatus, the roller member which employs the configuration of this example is not limited to the charging roller and, for example, the developing roller 32 is also applicable.

The charging roller 66 and the developing roller are conductive rollers (having an electric resistance of 10⁸Ω or lower), and are applied with a voltage at the time of image formation. However, the roller members are not limited thereto. The roller members to which the voltage is not applied at the time of image formation are also applicable, and a roller member covered with an insulative resilient member on an outer periphery of the metallic shaft 66a.

### Example 2

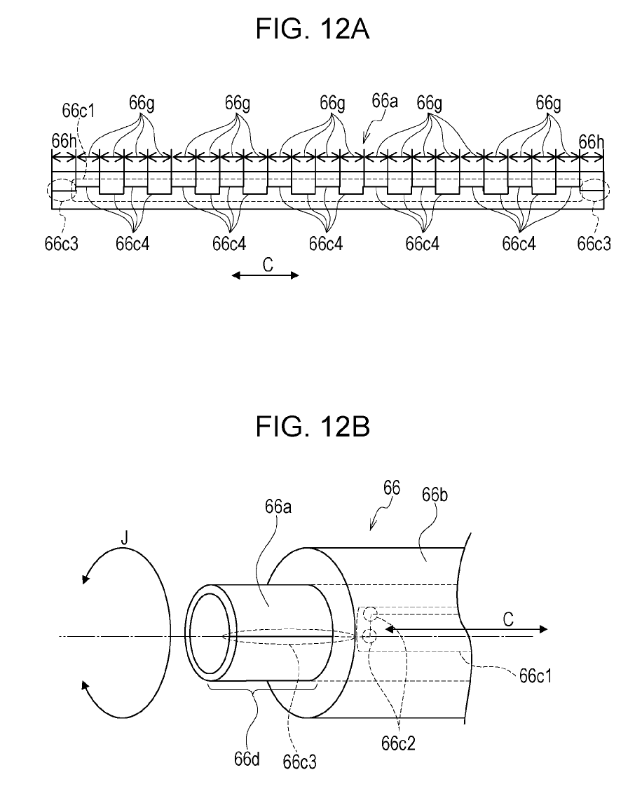

Referring now to FIGS. 12A and 12B, a configuration of Example 2 will be described.

FIG. 12A is an explanatory view illustrating the shaft portion 66a. FIG. 12B is a detailed drawing illustrating the end portion of the charging roller 66. Example 2 is the same as Example 1 in those other than the arrangement of the projection and depression portion 66c1 of the mating portion in the axial direction C of the charging roller 66 and the dimensional relationship of a width 66g.

Here, a width 66f (a width in the axial direction) of each of the projection and depression portion 66c4 of the projection and depression area 66c1 at the mating portion in the axial direction C of the charging roller 66 are set to be the same, so that the projection and depression portion 66c4 are arranged equidistantly. In other words, all the widths in the axial direction in the projections 66k13 on the one end portion and the projections 66k23 on the other end portion are equal as the metallic plate 66k illustrated in FIG. 14B.

In this manner, by equalizing the width 66f, the same strength is achieved irrespective of the direction of twisting of the shaft portion 66a in a direction indicated by an arrow J. Accordingly, the direction of the axial direction C of the shaft does not need to be selected to use, the process of selecting the direction of the shaft is eliminated at the time of assembly, so that the cost may be reduced.

Although a configuration having no gap in engagement of the projections and depressions at the mating portion is preferable in terms of strength, a gap may be partly generated.

### Example 3

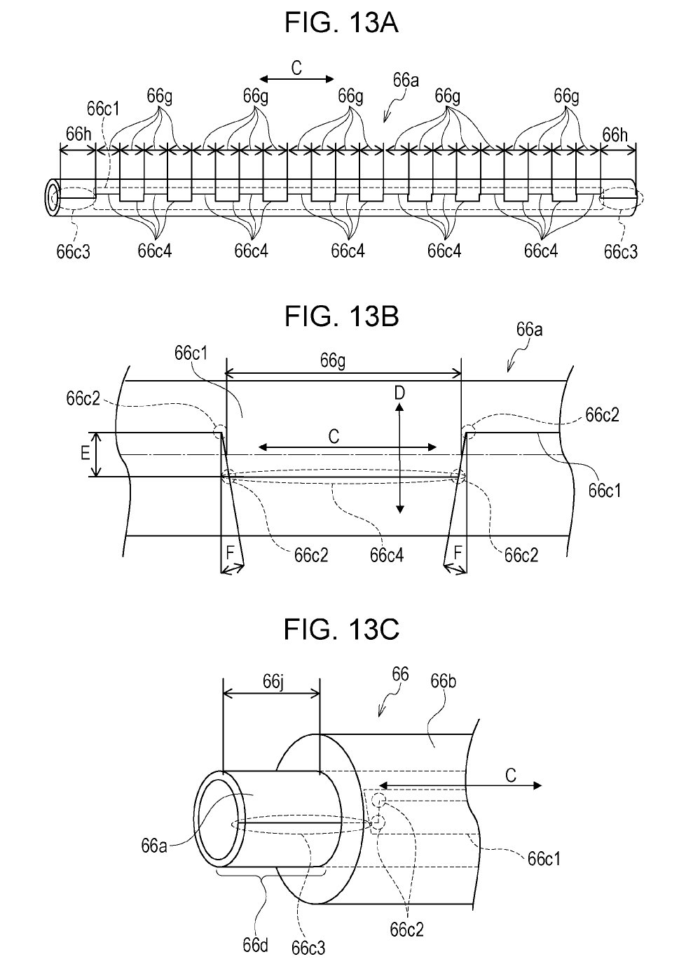

Referring now to FIGS. 13A to 13C, a configuration of Example 3 will be described. FIG. 13A is an explanatory view illustrating the shaft portion 66a. FIG. 13B is an explanatory view illustrating the projection and depression portion 66c1. FIG. 13C is a detailed drawing illustrating an end portion of the charging roller 66.

Example 3 is the same as Example 2 in those other than the dimensional relationship between the width 66g of the projection and depression portion 66c1 of the mating portion and the width 66h of the mating portion at the end portion in the axial direction C of the charging roller 66.

### Configuration of Charging Roller

The length of one of the widths 66h of the straight areas 66c3 at the mating portion in the axial direction C of the charging roller 66 is set to be longer than that of the width 66g of one of the projection and depression portion 66c4 in the axial direction C of the charging roller 66.

In this example, the width 66h of the straight areas 66c3 is set to 16 mm, and the width 66g of one of the projection and depression portion 66c4 is set to 10.5 mm.

The width 66h of the straight areas 66c3 may be set to 4 to 30 mm and the width 66g of one of the projection and depression portions 66c4 may be set to a desired value, smaller than the width 66h of the straight portions 66c3. A width 66j of the end portion 66d illustrated in FIG. 13C is preferably at least on the order of 4 mm in order to secure the width of sliding movement with respect to the bearings 67L and 67R in the case where this part is used for manufacture or in terms of the product function. Therefore, the width 66h of the straight areas 66c3 is also preferable to be at least 4 mm.

The projection and depression area 66c1 of the mating portion is inclined at the angle F with respect to the direction D perpendicular to the axial direction C of the shaft portion 66a at engaging portions between the depressions and the projections. In other words, the depressions which constitute part of the projection and depression area 66c1 are depressed obliquely in the direction D by the angle F and a width of the depression on the bottom side (the length in the direction C) is smaller than the width of the depression on the opening side. In the same manner, the projections which constitute part of the projection and depression area 66c1 project obliquely in the direction D by the angle F.

It is because the depressions and the projections can easily be mated with the presence of the angle F (>0°). In this example, the value F is set to 3 degrees. However, a desired angle F between 0 and 10 may be selected (0°<F≦10°).

The outer diameter of the shaft portion 66a is φ6 mm, an inner diameter is φ4.8 mm. However, the outer diameter may be set as desired between 3 to 15 mm, and the inner diameter may be set as desired in a range obtained by subtracting a thickness (0.3 to 2 mm) of the metallic plate 66a1 from the outer diameter. The inner diameter of the shaft portion 66a does not have to be a circular shape if it is not required in terms of function of the product and manufacture.

In the process of bending the metallic plate 66k, for example, the projections and depressions may be formed inside (inner peripheral side) of the shaft portion 66a. Alternatively, a space does not have to be formed in the interior of the shaft portion 66a. For example, if an attempt is made to reduce the diameter of the shaft portion 66a with respect to the thickness of the metallic plate 66k, an internal space of the shaft portion 66a may substantially disappeared if the metallic plate 66k is bent to form the shaft portion 66a. Alternatively, filling the internal space of the shaft portion 66a by filling the interior of the shaft portion 66a with a reinforcing member in order to improve the strength of the shaft portion 66a is also conceivable.

In other words, in this application, if the shaft portion 66a has a cylindrical shape, it does not necessarily means that a space is formed in the interior of the shaft portion 66a, or a cross section of the internal space of the shaft portion 66a has a circular shape.

The projecting amount (=depressing amount) E of the projection and depression portion 66c1 and the projecting amount F of the straight portion 66c3 are the same in dimensional relationship and the value E is 2 mm, and the value F is 1 mm (not illustrated).

A projecting corner R or a recessed corner R may be provided at the corner portions 66c2 as needed (the projecting corners of the projections and the recessed corners of the depressions may have a curved surface). Although a configuration having no gap in engagement of the projections and depressions at the mating portion 66c (projection and depression area 66c1) is preferable in terms of strength, a gap may be partly generated.

By setting the width 66h of the straight areas 66c3 to be larger than the width 66g of the projection and depression portion 66c4 in this manner, the length of the end portion 66d may be increased, so that a wide (long in the axial direction C) sliding portion with respect to the bearing may be secured.

In Examples 1 to 3 described above, an example in which the charging roller of this disclosure is assembled to the process cartridge has been described. However, this disclosure is not limited thereto, and may the charging roller may be assembled to the image forming apparatus body in which a cartridge system is not employed. A configuration in which a minimum unit of only the charging roller can be mounted on and demounted from the process cartridge or the image forming apparatus body is also applicable.

In conclusion, summary of the advantageous effects of the Examples 1 to 3 disclosed in this application will be described below. In other words, according to the configuration disclosed in the respective examples, reducing the resistance at the metallic shaft and the bearing portion at the time of rotation of the roller member while increasing the strength of the metallic shaft is achieved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-074541 filed Mar. 31, 2014, which is hereby incorporated by reference herein in its entirety.

What is claimed is:

1. A roller member used in an image forming apparatus comprising: a metallic shaft; and a covering layer configured to cover the metallic shaft, wherein
the metallic shaft has a cylindrical shape formed so that one end portion and the other end portion of the metallic plate oppose each other,
the one end portion and the other end portion each include a straight portion, a projection, and a depression,
the projection on the one end portion engages the depression on the other end portion, and the projection on the other end portion engages the depression on the one end portion in an opposing area in which the one end portion and the other end portion oppose each other,
a straight area in which a straight portion on the one end portion and a straight portion on the other end portion oppose each other is located outside a projection and depression area in which the projection on the one end portion and the projection on the other end portion are aligned in an axial direction of the metallic shaft, and
the projection and depression area is entirely covered with the covering layer and at least part of the straight area is exposed from the covering layer.

2. The roller member according to claim 1, wherein
the one end portion includes a plurality of the projections and the depressions,
the other end portion includes a plurality of the projections and the depressions, and
the projections on the one end portion and the projections on the other end portion are arranged alternately in the projection and depression area.

3. The roller member according to claim 2, wherein widths of the plurality of projections provided on the one end portion and on the other end portion measured in the axial direction are all the same.

4. The roller member according to claim 1, wherein a width of the straight portion is larger than the width of the projections on the one end portion and the width of the projections on the other end portion in the axial direction.

5. The roller member according to claim 1, wherein the depressions on the one end portion and the depressions on the other end portion are depressed obliquely with respect to a direction perpendicular to the axial direction, and the depressions have a width on a bottom side smaller than a width on an opening side in the axial direction.

6. The roller member according to claim 1, wherein the straight areas are provided on both end sides of the projection and depression area.

7. The roller member according to claim 1, wherein the roller member is a charging roller configured to charge an image bearing member configured to bear an image.

8. The roller member according to claim 1, wherein the roller member is a developing roller configured to bear developer for developing a latent image formed on the image bearing member.

9. A roller supporting mechanism used in an image forming apparatus comprising:
the roller member according to claim 1; and
a bearing portion configured to support an exposed portion of the metallic shaft exposed from the covering layer.

10. A roller supporting mechanism used in an image forming apparatus comprising: a roller member; and a bearing portion configured to support the roller member, wherein
the roller member includes a metallic shaft and a covering layer configured to cover the metallic shaft,
the metallic shaft has a cylindrical shape formed so that one end portion and the other end portion of the metallic plate oppose each other,
the one end portion and the other end portion each includes a straight portion, a projection, and a depression,
the projection on the one end portion engages the depression on the other end portion, and the projection on the other end portion engages the depression on the one end portion in an opposing area in which the one end portion and the other end portion oppose each other,
a straight area in which a straight portion on the one end portion and a straight portion on the other end portion oppose each other is located outside a projection and depression area in which the projection on the one end portion and the projection on the other end portion are aligned in an axial direction of the metallic shaft, and
the bearing portion is configured to support an exposed portion of the metallic shaft exposed from the covering layer, and a contact portion of the exposed portion which comes into contact with the bearing portion is provided with the straight area and is not provided with the projection and depression area.

11. The roller supporting mechanism according to claim 10, wherein
the one end portion includes a plurality of the projections and the depressions,
the other end portion includes a plurality of the projections and the depressions, and
the projections on the one end portion and the projections on the other end portions are arranged alternately in the projection and depression area.

12. The roller supporting mechanism according to claim 10, wherein widths of the plurality of projections provided on the one end portion and on the other end portion measured in the axial direction are all the same.

13. The roller supporting mechanism according to claim 10, wherein the straight areas are provided on both end sides of the projection and depression area.

14. The roller supporting mechanism according to claim 10, wherein a width of the straight portion is larger than the width of the projections on the one end portion and the width of the projections on the other end portion in the axial direction.

15. The roller supporting mechanism according to claim 10, wherein the depressions on the one end portion and the depressions on the other end portion are depressed obliquely with respect to a direction perpendicular to the axial direction, and the depressions have a width on a bottom side smaller than a width on an opening side in the axial direction.

16. The roller supporting mechanism according to claim 10, wherein the roller member is a charging roller configured to charge an image bearing member configured to bear an image.

17. The roller supporting mechanism according to claim 10, wherein the roller member is a developing roller configured to bear developer for developing a latent image formed on the image bearing member.

18. The roller supporting mechanism according to claim 9, wherein the roller supporting mechanism is capable of being mounted on and demounted from an apparatus body of the image forming apparatus as part of a cartridge.

19. The roller supporting mechanism according to claim 18, wherein the cartridge includes an image bearing member on which an image is formed.

20. A metallic shaft of a roller member used in an image forming apparatus, wherein
the metallic shaft has a cylindrical shape formed so that one end portion and the other end portion of the metallic plate oppose each other,
the one end portion and the other end portion each include a straight portion, a plurality of projections, and a plurality of depressions,
the projection on the one end portion engages the depression on the other end portion, and the projection on the other end portion engages the depression on the one end portion in an opposing area in which the one end portion and the other end portion oppose each other,
a straight area in which a straight portion on the one end portion and a straight portion on the other end portion oppose each other is located outside a projection and depression area in which the projection on one end portion and the projection on the other end portion are aligned in an axial direction of the metallic shaft, and
the projecting portions on the one end portion and the projecting portions on the other end portions are arranged alternately in the projection and depression area, and widths of a plurality of the projections provided on the one end portion and a plurality of projections provided on the other end portion are all the same in the axial direction of the metallic shaft.
